(19) United States
(12) Patent Application Publication
(10) Pub. No.: US 2024/0332542 A1
(43) Pub. Date: Oct. 3, 2024

(54) CARBON FIBER-CARBON NANOTUBE-POLYMER BASED COMPOSITE CURRENT COLLECTOR

(71) Applicant: UT-Battelle, LLC, Oak Ridge, TN (US)

(72) Inventors: Jianlin Li, Oak Ridge, TN (US); Jaswinder K. Sharma, Oak Ridge, TN (US)

(21) Appl. No.: 18/602,202

(22) Filed: Mar. 12, 2024

Related U.S. Application Data
(60) Provisional application No. 63/455,587, filed on Mar. 30, 2023.

(51) Int. Cl. H01M 4/66; H01M 4/02; H01M 4/04

(52) U.S. Cl. CPC H01M 4/668; H01M 4/0409; H01M 4/0419; H01M 2004/021; H01M 2004/027; H01M 2004/028

(57) ABSTRACT

A composite current collector for an electrode is provided. The composite current collector includes a plurality of directionally aligned carbon fibers, a polymer matrix material, and conductive material dispersed in the polymer matrix material. The directionally aligned carbon fibers are impregnated with the polymer matrix material including the dispersed conductive material which may be carbon nanotubes, VGCF, graphene platelets, or carbon black. The polymer matrix material forms a thin film that fills interstitial spaces between the directionally aligned carbon fibers. The polymer matrix material may be, for example, one of poly(L-lactide-co-ε-caprolactone) and polyvinylidene fluoride (PVDF). The composite current collector may be free of metal, and the thin film may have a thickness in a range of 5-50 μm. A method of making the composite current collector, and an electrode including the composite current collector and an electrode material coated on the composite current collector are also provided.

### CROSS-REFERENCE TO RELATED APPLICATIONS

This application claims the benefit of U.S. Provisional Application No. 63/455,587, filed Mar. 30, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to current collectors for battery electrodes and other applications.

### BACKGROUND OF THE INVENTION

Lithium-ion batteries (LIBs) have become a primary means of energy storage for applications ranging from grid storage to electrical vehicles. Extensive research has been performed to improve the energy and power density, fast charging capability, and safety of lithium-ion batteries while reducing cost through development of high-performance materials and advanced materials processing. Lithium-ion batteries are made of several components including an anode, a cathode, a separator, current collectors, and an electrolyte. While substantial attention has been given to anodes and cathodes, little research has been conducted on current collectors.

Current collectors mainly serve as a substrate that provides mechanical support in electrode fabrication as well as to transport electrons between electrodes. Traditional current collectors are aluminum foils and copper foils for cathodes and anodes, respectively. Current collectors account for 5-10 wt. % of the total mass of a battery cell and up to 9% of material cost. Since current collectors are an electrochemically inactive component and don't contribute to capacity, it is desirable to reduce their thickness, weight and cost while maintaining sufficient mechanical strength and electrical conductivity.

While Al-metal current collectors are currently being used for cathodes, pure Al-metal is electrochemically unstable under high voltages. Its application as a current collector for high voltage cathodes relies on a thin surface layer of Al₂O₃ and/or the use of LiPF₆-based electrolytes. LiPF₆ helps in making an AlF₃/LiF coating on the Al-metal which stabilizes the Al-metal under high voltage conditions (≥3.7 V). Similarly, copper foil is electrochemically stable at anode electrochemical potentials (i.e., 0-2 V vs. Li/Li⁺), but it could still have electrochemical pitting corrosion resulting from the hydrofluoric acid (HF) produced by a chain of reactions (equations 1-3). HF is produced by the reaction of LiPF₆ salt present in commonly used electrolytes with trace amounts of water that may be present either in the electrolyte itself or that are incorporated during cell fabrication.

$$\\ \begin{matrix}{LiPF}_{6} \to LiF + {PF}_{5} & ( 1 )\end{matrix}$$

$$\\ \begin{matrix}{PF}_{5} + {H}_{2} O \to 2 HF + {PF}_{3} O & ( 2 )\end{matrix}$$

$$\\ \begin{matrix}{CuO}_{x} + 2 x HF \to {CuF}_{2} + x {H}_{2} O & ( 3 )\end{matrix}$$

Recently, other metals or metal-alloys have been investigated as current collectors including stainless steel for cathodes, Ni and Ni-based alloys for anodes, and some polymers with nickel coating for anodes. However, the use of metal current collectors requires separating them from electrodes and followed by recycling during battery recycle as they are a valuable component.

In addition to planar current collectors, three-dimensional (3D) current collectors have also been investigated. 3D current collectors are mainly composed of either metal or carbon-based materials. Metal 3D conductors include foams or 3D assemblies of metal nanostructures. Similarly, 3D carbon current collector examples include graphene foams, carbon nanotube (CNT) foams, and the like. 3D current collectors can provide shorter and less-tortuous paths for electron transfer along the through-plane of electrodes, and thus can be useful for thick electrodes and high-power density applications. However, use of 3D current collectors reduces the volumetric energy density and increases current collector reactions with electrolyte as well as posing challenges for scale up.

Carbon-based materials are of particular interest because of their high thermal or electrical conductivities. However, when carbon fibers (CFs) are used without any additional coating, the adhesion of the current collector with the cathode is unsatisfactory. To address this, a polyacrylonitrile (PAN) coating on the CFs can be applied in order to improve the adhesion strength of the fibers with the cathode layer. Though adhesion strength can be improved, there are still some areas where fibers are absent which may result in inhomogeneous current density in the cathodes. Therefore, there is a need for a carbon-fiber-based current collector that can provide homogenous current density and improved adhesion of the cathode layer with the fibers, while also not allowing the slurry to pass through the current collector during cathode fabrication.

### SUMMARY OF THE INVENTION

A composite current collector for an electrode is provided. The composite current collector includes a plurality of directionally aligned carbon fibers, a polymer matrix material, and a conductive material dispersed in the polymer matrix material. The directionally aligned carbon fibers are impregnated with the polymer matrix material including the dispersed conductive material. The polymer matrix material forms a thin film that fills interstitial spaces between the directionally aligned carbon fibers.

In specific embodiments, the composite current collector is free of metal.

In specific embodiments, the polymer matrix material includes poly(L-lactide-co-ε-caprolactone) or polyvinylidene fluoride (PVDF).

In specific embodiments, the conductive material is present in an amount of approximately 1 wt. % to 70 wt. % relative to a total weight of the polymer matrix material and conductive material.

In specific embodiments, the thin film has a thickness in a range of 5-50 μm.

In particular embodiments, the thin film has a thickness in a range of 7-15 μm.

In specific embodiments, the conductive material is selected from carbon nanotubes, vapor grown carbon fibers (VGCF), graphene platelets, and carbon black.

An electrode is also provided. The electrode includes the composite current collector and an electrode material coated on the composite current collector.

In specific embodiments, the electrode has a thickness in a range of 10 to 500 μm.

In specific embodiments, the electrode material is further defined as a cathode active material. In other embodiments, the electrode material is further defined as an anode active material.

A method of making a composite current collector is also provided. The method includes preparing a slurry of polymer matrix material and conductive material mixed in a solvent. The method further includes directionally aligning carbon fibers. The method further includes impregnating the directionally aligned carbon fibers with the slurry to form a film layer that fills interstitial spaces between the directionally aligned carbon fibers.

In specific embodiments, the polymer matrix material includes poly(L-lactide-co-ε-caprolactone) or polyvinylidene fluoride (PVDF).

In specific embodiments, the solvent is either chloroform or N-Methylpyrrolidone (NMP).

In specific embodiments, the conductive material is pre-dispersed in a carrier resin.

In specific embodiments, the conductive material is present in the slurry in an amount of approximately 1 wt. % to 70 wt. % based on the total weight of the slurry.

In specific embodiments, the conductive material is selected from carbon nanotubes, vapor grown carbon fibers (VGCF), graphene platelets, and carbon black.

In specific embodiments, the composite current collector has a thickness in a range of 5-50 μm.

In particular embodiments, the composite current collector has a thickness in a range of 7-15 μm.

In specific embodiments, the film layer of the slurry is formed by blade-coating, slot-die coating, spin coating, or spray coating.

These and other features of the invention will be more fully understood and appreciated by reference to the description of the embodiments and the drawings.

### BRIEF DESCRIPTION OF THE DRAWINGS

FIG. 1 is a schematic view of a method of making a composite current collector in accordance with embodiments of the disclosure;

FIG. 2 is a graph of electrochemical impedance spectroscopy (EIS) profiles for half cells having cathodes deposited on a composite current collector in accordance with some embodiments of the disclosure and half cells having cathodes deposited on aluminum foil;

FIG. 3 is a graph of a thermogravimetric analysis (TGA) performed on the composite current collector;

FIG. 4 is a graph of a cyclic voltammogram for the composite current collector;

FIG. 5 is a graph of electrochemical performance (rate capability and cyclic stability) of half cells having cathodes coated on the composite current collector and aluminum foil;

FIG. 6 is a graph of voltage-capacity profiles for half cells having cathodes coated on the composite current collector and aluminum foil;

FIG. 7 is a graph of electrochemical performance (cyclic stability and Coulombic efficiency) of half cells having cathodes coated on the composite current collector and aluminum foil;

FIG. 8 is a graph of a thermogravimetric analysis (TGA) performed on a composite current collector in accordance with other embodiments of the disclosure;

FIG. 9 is a graph of a cyclic voltammogram for the composite current collector;

FIG. 10 is a graph of electrochemical impedance spectroscopy (EIS) profiles for half cells having graphite anodes deposited on the composite current collector and half cells having graphite anodes deposited on copper foil;

FIG. 11 is a graph of electrochemical performance (rate capability and cyclic stability) of half cells having lithium-metal electrodes coated on the composite current collector and copper foil;

FIG. 12 is a graph of a voltage profile of a half cell with only the composite current collector;

FIG. 13 is a graph of electrochemical performance (rate capability and cyclic stability) of half cells having graphite anodes coated on the composite current collector and copper foil;

FIG. 14 is a graph of a voltage profile of half cells having graphite anodes coated on the composite current collector and copper foil;

FIG. 15 is a graph of electrochemical performance (rate capability and cyclic stability) of full cells having graphite anodes coated on the composite current collector and copper foil, paired with NMC811 cathodes;

FIG. 16 is a graph of voltage-capacity profiles of cells with graphite anodes coated on the composite current collector, paired with NMC811 cathodes;

FIG. 17 is a graph of voltage-capacity profiles of cells with graphite anodes coated on copper foil, paired with NMC811 cathodes; and

FIG. 18 is a graph of long-term cycling and Coulombic efficiency of cells having graphite anodes coated on the composite current collector and copper foil, paired with NMC811 cathodes.

### DETAILED DESCRIPTION OF THE CURRENT EMBODIMENTS

In one aspect, an improved composite current collector is provided that combines conductive material (e.g., carbon nanotubes), having high electrical conductivity, with carbon fibers, having high mechanical strength). In another aspect, a method of forming a carbon fiber, conductive material, and polymer-based composite current collector is provided. The method includes forming a thin film of conductive material-polymer slurry on aligned carbon fibers. In yet another aspect, an electrode including the composite current collector is also provided. The composite current collector, electrode including the composite current collector, and method of making the composite current collector are discussed in greater detail below.

The composite current collector includes a plurality of directionally aligned carbon fibers. By directionally aligned, it means that the strands of carbon fiber are generally or closely parallel to each other. Further, the carbon fiber strands may be long strands that all extend in the same general longitudinal direction along the length of the strands. The carbon fiber is not particularly limited and may be, for example, M7 carbon fiber. The carbon fibers provide elongated, longitudinal pathways along which current can travel.

The composite current collector further includes a polymer matrix material. The polymer matrix material may be, for example, a poly(L-lactide-co-ε-caprolactone) or polyvinylidene fluoride (PVDF). In the case of the polymer being the polylactic acid (PLA)-polycaprolactone (PCL), the ratio of PLA:PCL may be approximately 70:30 mol %. However, it should be understood that polymers other than PLA-PCL or PVDF, may be used depending upon their electrochemical stability for the electrode being used such as polyacrylonitrile (PAN), polyvinylpyrrolidone (PVP), polyetherimide, polyethylene naphthalate, polyethylene terephthalate, poly(vinyl chloride), polyethylene ether ketone, polylactide and carboxymethyl cellulose. The polymer matrix material also may include a mixture of two or more of these polymers.

A conductive material is dispersed in the polymer matrix material. In certain embodiments, the conductive material is carbon nanotubes. The carbon nanotubes are not particularly limited and may be used neatly or pre-dispersed in a carrier resin material (which may be different than the polymer matrix material above). For example, one carbon nanotube pre-dispersion includes 10% carbon nanotubes in triethylene glycol dimethacrylate. In other embodiments, the conductive material may be, for example, vapor grown carbon fibers (VGCF), graphene platelets, or carbon black. In any event, the conductive material present in an amount of approximately 1 wt. % to 70 wt. % relative to a total weight of the polymer matrix material and conductive material, optionally 1 wt. % to 40 wt. %, optionally 1 wt. % to 20 wt. %, optionally 5 wt. % to 40 wt. %, optionally 5 wt. % to 20 wt. %, optionally 10 wt. % to 20 wt. %, optionally 5 wt. % to 15 wt. %, optionally 5 wt. % to 10 wt. %.

In the composite current collector, the directionally aligned carbon fibers are impregnated with the polymer matrix material including the dispersed conductive material which may be carbon nanotubes. The polymer matrix material forms a thin film that fills interstitial spaces between the directionally aligned carbon fibers to form the composite current collector. The thin film has a thickness in a range of 5-50 μm, optionally a range of 5-40 μm, optionally a range of 5-30 μm, optionally a range of 5-20 μm, optionally a range of 5-15 μm, optionally a range of 7-15 μm, optionally a range of 8-15 μm, optionally a range of 9-15 μm, optionally a range of 10-15 μm, optionally a range of 5-14 μm, optionally a range of 5-13 μm, optionally a range of 5-12 μm, optionally a range of 5-11 μm, optionally a range of 5-10 μm. The thin layer leaves portions of surfaces of the carbon fibers partially exposed on both sides of the thin film, providing direct contact through the carbon fibers surfaces from one side of the composite to the other. The presence of the conductive material in the polymer matrix film ensures that all areas of the composite have reasonable electrical conductivity. The conductive material allows current to move across and between the current pathways formed by the elongated carbon fibers, thereby providing connections between the carbon fiber pathways. Advantageously, in various embodiments the composite current collector is free of any metal material, i.e., the composite current collector is metal-free.

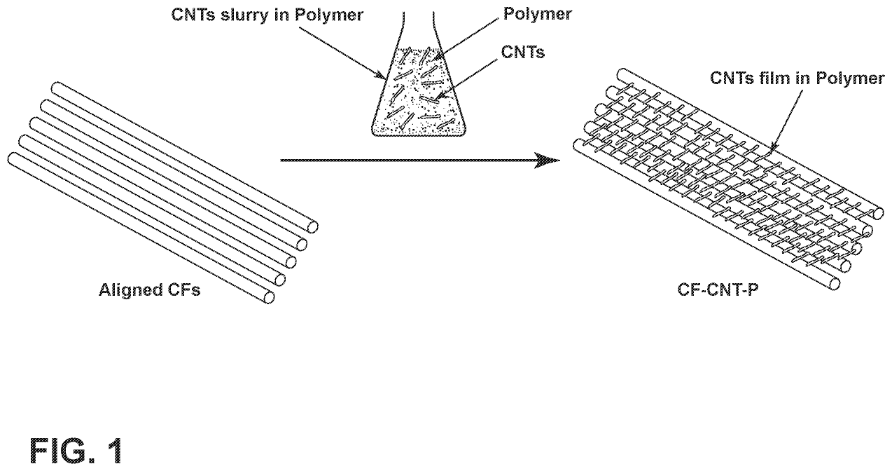

With reference to FIG. 1, a method of making the composite current collector includes preparing a slurry of polymer matrix material and conductive material mixed in a solvent. The polymer matrix material and conductive material are the same as those described above. The solvent is not particularly limited and can be any solvent capable of dissolving the polymer. By way of example, suitable solvents include but are not limited to chloroform and N-methylpyrrolidone (NMP). The conductive material is present in the slurry in an amount of approximately 1 wt. % to 70 wt. % based on the total weight of the slurry. The method also includes directionally aligning the carbon fibers, for example, on a support surface. Again, directionally aligned means that the fibers extend in the same general longitudinal direction and are thus parallel or nearly parallel (for example, within +5°, optionally within +10°, optionally within)+20°. However, it does not require that all the fibers are exactly parallel to each other, nor does it preclude certain fiber(s) overlapping other fiber(s). The method next includes impregnating the directionally aligned carbon fibers with the slurry to form a thin film layer that fills interstitial spaces between the directionally aligned carbon fibers. The film layer can be formed by various methods including but not limited to doctor blade coating (generally “blade-coating”), slot-die coating, spin coating, and spray coating.

In various embodiments, an electrode includes an electrode material coated on the composite current collector. The electrode may be a cathode or an anode. In the case of a cathode, the electrode material is a cathode active material. By way of example, suitable cathode active materials include, but are not limited to, lithium compounds, particularly a lithium-bearing metal oxide. Examples of such compounds include LiCoO₂, LiMn₂O₄, LiNiO₂, LiCrO₂, LiFePO₄, LiNiO₂, LiMn₂O₄, LiV₂O₅, LiTiS₂, LiMOS₂, LiMnO₂, LiFe_{1-z}MyPO₄, as well as variations of lithium nickel oxides, lithium nickel manganese oxides, lithium nickel manganese cobalt oxides, lithium nickel manganese iron oxides, and the like, exemplified by those having general formulas such as LiNiₓMn_{y}O₂, Li_{1+z}NiₓMn_{y}Co_{1-x-y}O₂, LiNiₓCo_{y}Al₂O₂, LiNiₓCo_{y}Mn_{z}O₂, etc., where each x, y, and z is typically a mole fraction of from 0 to 1, where x+y+z=1. Other such compounds include LiMPO₄ wherein M is one of Fe, Mg, or Mn, LiNiₓMn_{y}Co_{1-x-y}O₂, LiNi_{1.5}Mn_{0.5}O₄, and LiMO₂ wherein M is one of or a combination of two or more of Ni, Mn, Co, Fe, Al, Ti, or Zn. In the case of an anode, the electrode material is an anode active material. Typically, anode active materials may comprise an electroconductive carbon compound, but non-carbon anode active materials may be utilized. By way of example, suitable anode active materials include, but are not limited to, graphite, graphene, other various forms of carbon such as paracrystalline carbon (e.g. carbon black or hard carbon), silicon, silicon oxide, germanium, lithium titanium oxide, niobium oxide, and titanium niobium oxide. The electrode has a thickness in a range of 10 to 500 μm, optionally a range of 20 to 500 μm, optionally a range of 30 to 500 μm, optionally a range of 40 to 500 μm, optionally a range of 50 to 500 μm, optionally a range of 60 to 500 μm, optionally a range of 70 to 500 μm, optionally a range of 80 to 500 μm, optionally a range of 90 to 500 μm, optionally a range of 100 to 500 μm, optionally a range of 200 to 500 μm, optionally a range of 300 to 500 μm, optionally a range of 400 to 500 μm, optionally a range of 50 to 100 μm, optionally a range of 50 to 200 μm, optionally a range of 50 to 300 μm, optionally a range of 50 to 400 μm, optionally a range of 50 to 500 μm.

### EXAMPLES

The present method is further described in connection with the following laboratory examples, which are intended to be non-limiting.

### Example 1—Current Collector 1

A slurry of carbon nanotubes and polymer matrix material (“CNT-polymer slurry”) was prepared by mixing pre-dispersed carbon nanotubes (Tuball Matrix 204 obtained from TUBALL) at 15 wt. % to poly(L-lactide-co-E-caprolactone) polymer (PLA:PCL=70:30 mol %; obtained from Sigma Aldrich) in chloroform at 2500 rpm for 30 minutes. This prepared slurry was used to impregnate carbon fibers (“CFs”) (M7 unsized obtained from Hexel Corporation). The CFs were ≈5-7 μm in diameter and well-aligned in a parallel direction. The CNT-polymer slurry-impregnated CFs were allowed to dry for at least 1 hour, optionally 6 hours, to obtain a composite current collector (“CF-CNT-P”). The CNT-polymer matrix was very thin and only filled in the interstitial space between the CFs and did not make a very thick conformal layer on the aligned CFs. This helps keep the CFs in direct contact with the cathode active material (when an electrode is formed, see below) and thus minimize the electrical resistance. The CNTs nicely connected the larger CFs, and thus provided a well-connected network of conductive material for electron transfer. The total thickness of the CF-CNT-P film was ≈7-15 μm. Additionally, the CF-CNT-P film was lighter in weight (1.0 to 1.8 mg/cm² with thickness ≈7-15 μm) compared to Al-foil (4.35 mg/cm² with thickness ≈15 μm). Lighter weight can further reduce the amount of inactive material in subsequently formed cathodes and thus can enhance the overall energy density of cells. The CF-CNT-P film was subsequently used as a current collector for further studies in place of Al-foil.

### Example 2—Current Collector 2

A slurry of carbon nanotubes and polymer matrix material (“CNT-P slurry”) was prepared by mixing 15 wt. % CNTs (SKYNANO Technologies-20210825-30-35 nm) with polyvinylidene fluoride (PVDF) (Kureha 9300) in N-methyl-2-pyrrolidone (NMP) for 45 minutes at a frequency of 30 vibrations per second using a Retsch-MM 400 mixture. The prepared slurry was used to infuse the CF layer (unsized M7 from Hexel Corp) and make a thin film. The wet CF-CNT-P dried for 24 hours at 80° C. The thickness of the dry CF-CNT-P film was approximately 8-15 μm. The CF-CNT-P composite had an electrical conductivity approximately equal to 10×10³ S/m. Although the electrical conductivity is lower than that of copper foil (5.8×10⁷ S/m), it is comparable with other carbon-based current collectors. The CF-CNT-P current collector was lighter (1.5 mg/cm²) than copper-based current collectors (8.7 mg/cm²). The CF-CNT-P film was subsequently used as a current collector for further studies in place of Cu-foil.

### Electrodes—Cathodes 1-2, Anode 1

A cathode slurry was prepared by mixing 90 wt. % LiNi_{0.6}Mn_{0.2}Co_{0.2}O₂ powder (NMC622 obtained from Targray) with 5 wt. % carbon black (Denka Li-100) and 5 wt. % polyvinylidene fluoride (PVDF, Solvay 5130) binder in N-methyl-2-pyrrolidone (NMP). The final solid content of the slurry was 55 wt. %. The slurry was mixed using a Retsch-MM 400 mixture for 1 hour at a frequency of 20 revolutions/s. The cathode coatings were fabricated on the CF-CNT-P current collector (Current Collector 1) using a doctor blade. The final thickness of cathode coating was ≈50 μm with a loading ≈1.2 mAh/cm (Cathode 1). Cathodes were punched for coin cell assembly. Punched electrodes were further dried overnight in a vacuum oven at 100° C. Coin cells were assembled inside an argon filled glovebox with lithium metal (obtained from MTI Corporation) as the counter electrode. 1.2 M LiPF₆ in 3:7 wt. % ethylene carbonate/ethyl methyl carbonate was used as the electrolyte.

An anode slurry was prepared by combining 92 wt. % graphite (Superior SLC 1520 T), 6 wt. % PVDF (Kureha 9300), and 2 wt. % carbon black (Imerys; C-NERGY C65). The slurry was mixed using a Retsch-MM 400 mixture for 45 minutes at a frequency of 25 vibrations per second. The final solid content of slurry was 55 wt. %. Anodes (Anode 1) were coated using a doctor blade on CF-CNT-P and copper foil current collectors.

Similarly, a cathode slurry was prepared by mixing 90 wt. % LiNi_{0.8}Mn_{0.1}Co_{0.1}O₂ (NMC811, Targray) powder with 5 wt. % PVDF (Solvay 5130) and 5 wt. % carbon black (Denka Li-100) in NMP. The final solid content of slurry was 55 wt. %. The slurry was mixed using a Retsch-MM 400 mixture for 45 minutes at a frequency of 25 vibrations per second. Cathode coatings (Cathode 2) were made on aluminum foil (MTI Corporation) by using a doctor blade.

As-coated electrodes (Anode 1; Cathode 2) were punched for coin cell assembly after being dried overnight in a vacuum oven at 110° C. Coin cells were assembled inside an argon-filled glove box. Celgard 2325 was used as a separator. 1.2 M LiPF₆ in 3:7 wt. % ethylene carbonate/ethyl methyl carbonate was used as the electrolyte.

### Comparative Example 1

A thin film of composite having 15% CNT to poly(L-lactide-co-ε-caprolactone) (PLA:PCL) polymer (PLA:PCL=70:30 mol. % ratio) in chloroform was prepared (CNT-P). The CNT-P comparative film did not include carbon fibers.

### Evaluation—Current Collector 1, Cathode 1

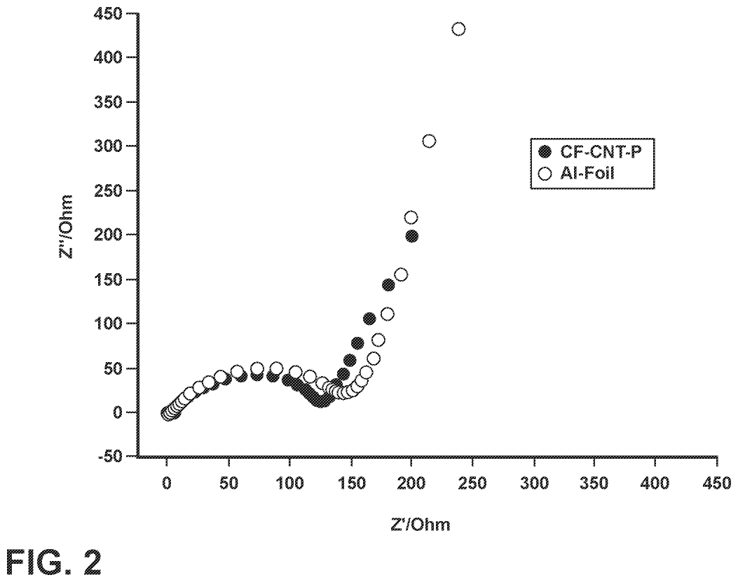

Electronic properties of the CF-CNT-P (Example 1—Current Collector 1) were measured by using a multimeter. CF-CNT-P has a through plane resistance ≈0.5 ohm when measured at the CFs and ≈20 ohm when measured at the polymer sites. Similarly, electronic properties of the films made of CNT-polymer composite alone (Comparative Example 1) were measured, which was in the Mega-ohm range. From electronic property measurements, it was certain that the CFs lower the electronic resistance in the CF-CNT-P and thus improve the electronic conductivity of the composite when compared to the composite made of CNT-polymer alone. The CFs provide continuous, longer pathways for both the in-plane and through-plane electronic conductivity, as composite is about the same thickness (7-15 μm) as the thickness of the CFs alone. Electrochemical impedance spectroscopy (EIS) measurements were performed on half cells with NMC622 cathodes on both CF-CNT-P and Al-foil as the current collector, respectively. As shown in FIG. 2, EIS analysis further revealed that cells having cathodes prepared on CF-CNT-P (Example 1) have similar contact resistance to that from the cells having cathodes prepared on Al-foil. However, the cathode with CF-CNT-P showed slightly lower charge transfer resistance when compared to that with Al-foil.

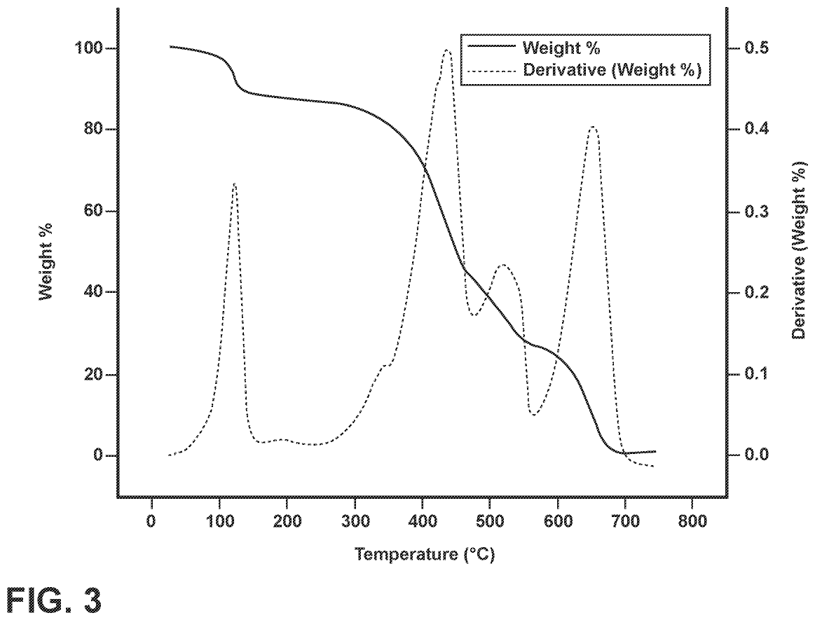

Thermogravimetric analysis (TGA) was performed to determine the thermal stability and the amounts of the different components in the CF-CNT-P composite. The peaks in the derivative plot shown in FIG. 3 correspond to the maximum mass loss rate of various components in the composite. The first peak at 100° C. corresponds to the residual solvent present in the system, while the peak at 400° C. corresponds to polymer degradation. Subsequent peaks indicate oxidation of the CNTs and CFs, respectively. This suggests that approximately 40% of the sample is CFs and CNTs. Omitting the weight loss of residual solvents, the TGA plot reveals that CF and CNT account for ≈53% (45/85×100) of the CF-CNT-P while polymer makes up the rest 47% (40/85×100). However, the polymer is much heavier in weight compared to the CNTs and CFs and only accounts for a very small volumetric fraction of the CF-CNT-P. The TGA results further support the high electronic conductivity of the CF-CNT-P because there is not much insulative polymer, and CF-CNT-P is mainly made of CFs and CNTs. A small amount of polymer is only used to keep the CF and CNT intact.

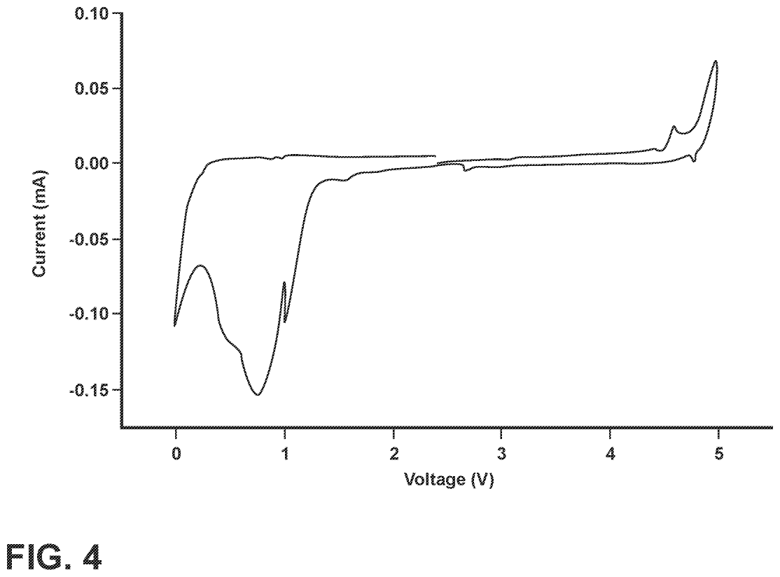

Cyclic voltammetry studies, which were performed in coin cells with Li and CF-CNT-P as the counter electrode and working electrode, respectively, reveal that the CF-CNT-P is stable in the voltage range (1.8-4.5V) as shown in FIG. 4. The current response at low voltage (<1.5 V) was ascribed to formation of solid electrolyte interphase and lithium intercalation in the CNTs and CFs.

To evaluate the behavior of CF-CNT-P under electrochemical cycling conditions, a NMC622 cathode with the CF-CNT-P as the current collector was tested. A cross-section of CF-CNT-P having a cathode layer revealed firmly intact cathode layer on the CF-CNT-P. The thickness was ≈7-15 μm and ≈50 μm for CF-CNT-P and cathode layer, respectively. Thickness variation of CF-CNT-P resulted from some areas having double layers of fibers while others having a single layer of fibers. SEM imaging showed the aligned CF embedded in the CNT-Polymer matrix. Similarly, SEM imaging of the cross-section of cathode layer on CF-CNT-P showed the well-aligned fibers coming out of the composite.

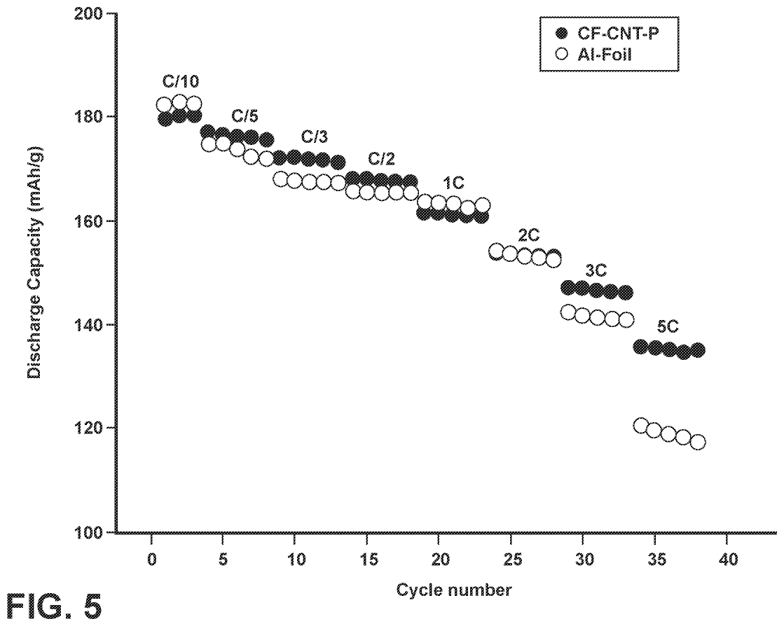

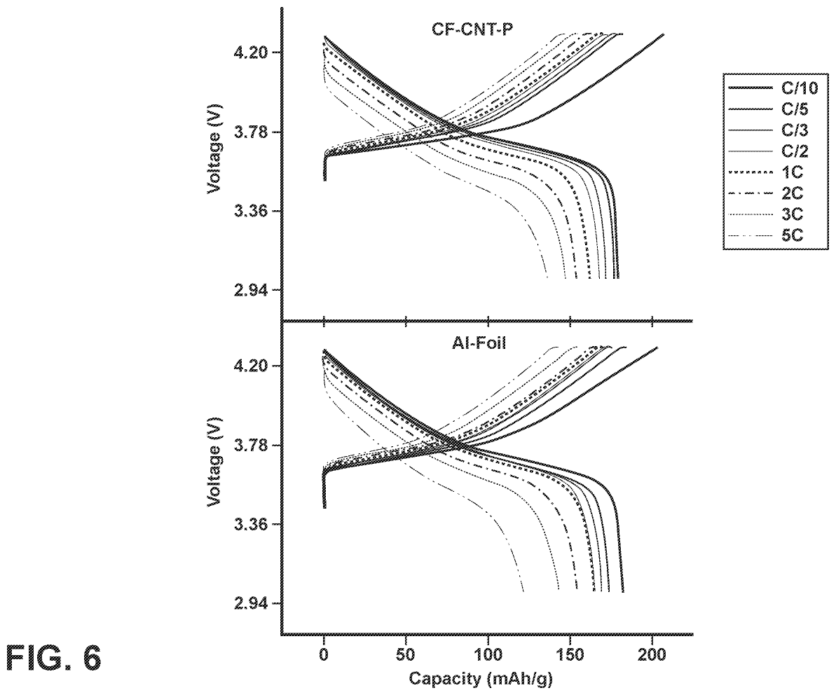

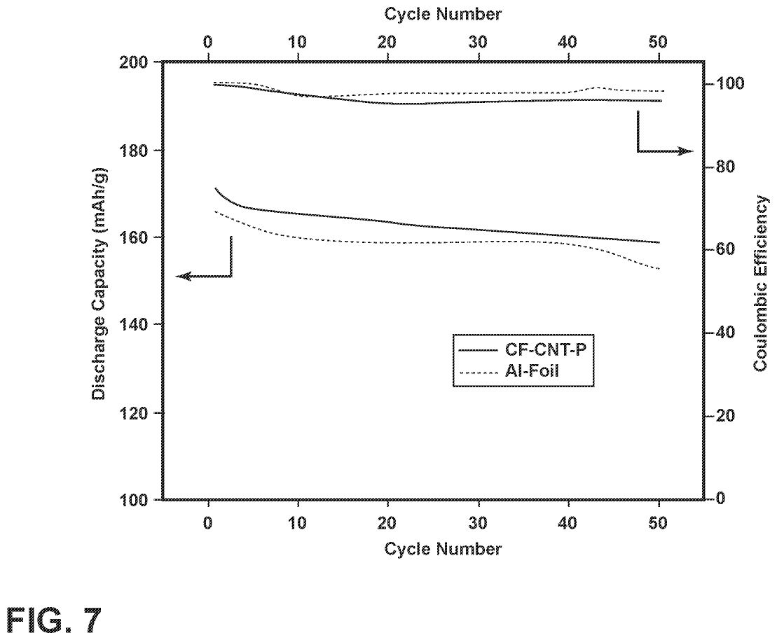

The rate capability and long cycling performance of cells were also evaluated. As shown in FIGS. 5 and 6, both electrodes show ˜180 mAh/g, which is typical for a NMC622 cathode. In addition, the cathode coated on the CF-CNT-P demonstrates comparable performance to that on aluminum foil at ≤2C. The performance is even higher at ≥3C. The better performance of CF-CNT-P polymer composite may be due to less charge transfer resistance between the CFs and active materials. Additionally, the longer conductive paths provided by the CFs are also helpful in enhancing the electron transfer. Similarly, as shown in FIG. 7, cycling studies on half cells prepared by using CF-CNT-P composite as current collectors showed that CF-CNT-P had an improvement in capacity retention during cycling (50 cycles at 1C) performance when compared to the half cells having cathodes prepared on an Al-foil current collector. CF-CNT-P cathode based half cells also showed similar coulombic efficiency to those of prepared by using cathodes on Al-foil current collector.

### Evaluation—Current Collector 2, Anode 1, Cathode 2

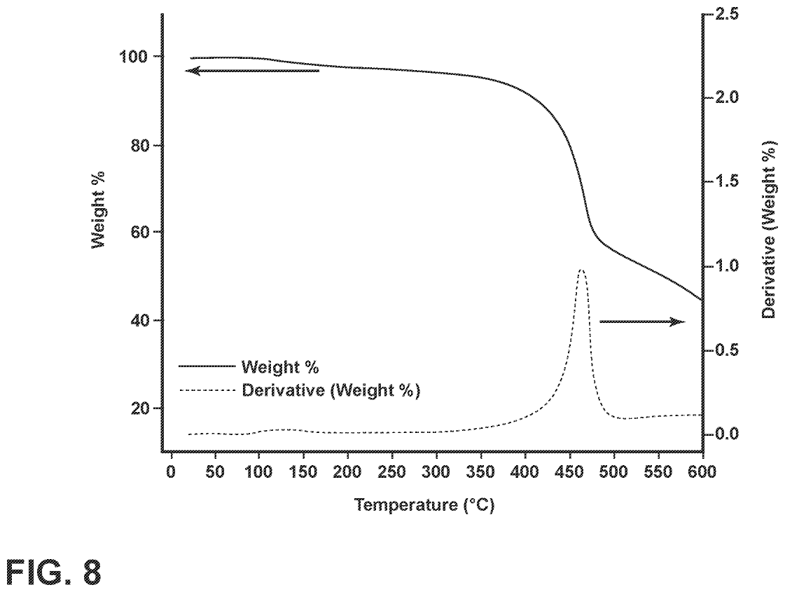

TGA was performed to deduce the ratio of the carbon content to the polymer content in the CF-CNT-P current collector. The thermogravimetric plot shown in FIG. 8 indicated that initially, a loss of water vapors or other contaminants adsorbed on the current collector occurred at a temperature <150° C. Upon further heating, the polymer started decomposing at approximately 350° C. and completely evaporated at approximately 475° C. The TGA study revealed that the CF-CNT-P was thermally stable up to approximately 350° C. The TGA plot also revealed that approximately 55% to 60% of the CF-CNT-P is composed of CFs and CNTs, and the remaining 40% to 45% is the PVDF polymer. A small amount of polymer is required to keep the CFs and CNTs intact and to make an impervious film, which helps in avoiding the leakage of slurry during the anode coating process. Because the polymer had a much higher tap density than the CFs and CNTs; it only accounted for a very small volumetric fraction of the CF-CNT-P.

The mechanical properties of the CF-CNT-P were measured using an MTS tensile tester equipped with a 2.0 kN load cell. The CF-CNT-P exhibited higher tensile strength (297±37 MPa) than that of copper foil (258±20 MPa). However, the Young's modulus of CF-CNT-P (4.67±1.9 GPa) was lower than that of the copper foil (˜50 GPa).

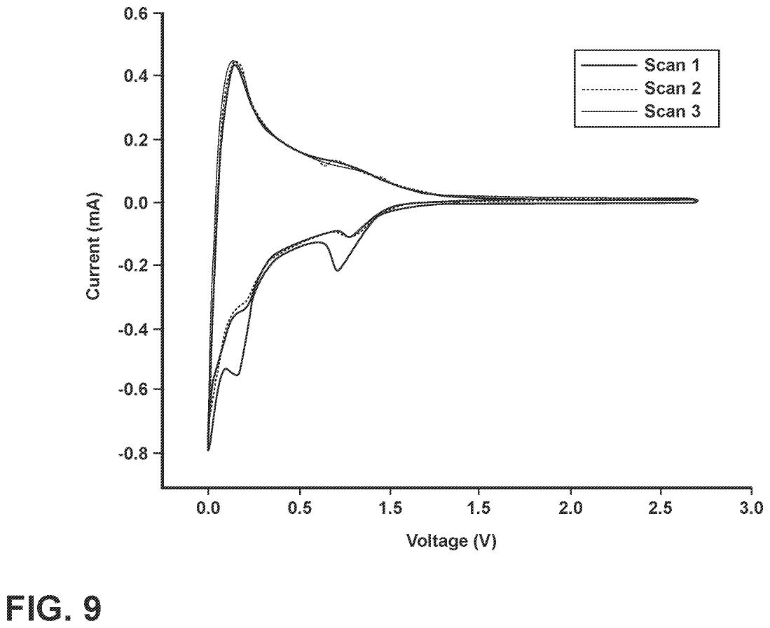

The electrochemical stability of the CF-CNT-P was tested using cyclic voltammetry (FIG. 3a). As shown in FIG. 9, three scans were performed in a voltage window of 5.0 mV to 2.0 V. The current response at low voltage (0.75 V and 0.2 V) in the first scan was attributed to the formation of a solid electrolyte interphase resulting from the reduction of electrolyte. The peaks at approximately 0.1 V correspond to lithium-ion intercalation (cathodic peak) and deintercalation (anodic peak) in and from CFs. CFs are known to have some graphitic carbon and can act as a host for lithium-ion intercalation. Thus, the CF-CNT-P could provide additional capacity while serving as a current collector. This additional capacity can further help increase the energy density of batteries. No other significant current peaks were detected in this voltage range, indicating good electrochemical stability for graphite anode applications.

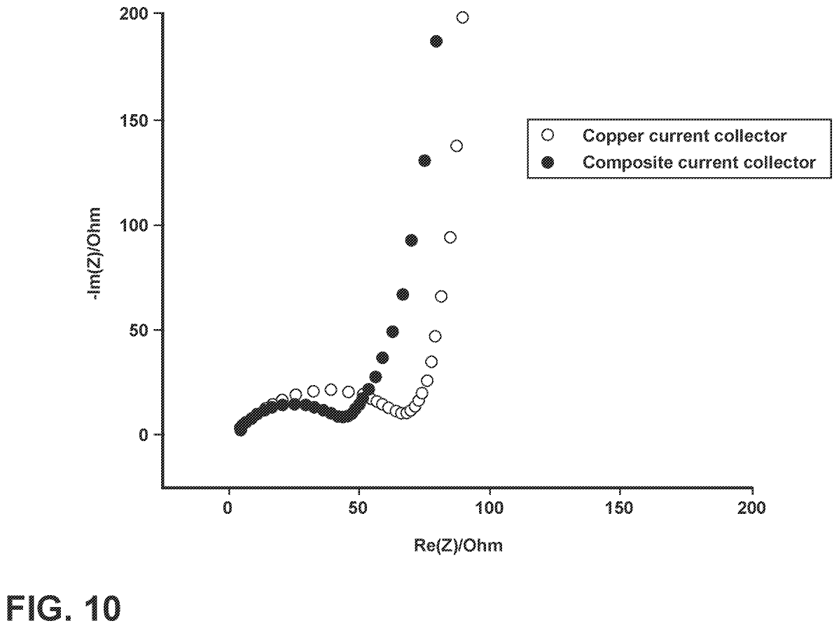

EIS measurements shown in FIG. 10 revealed that the cells having anodes on CF-CNT-P and copper foil have similar contact resistance, but the anodes on CF-CNT-P have slightly lower charge transfer resistance (48Ω) when compared with that of the anodes on copper foil (73Ω). In the plot, “−Im(Z)/Ohm” represents imaginary resistance and “Re(Z)/Ohm” represents real resistance.

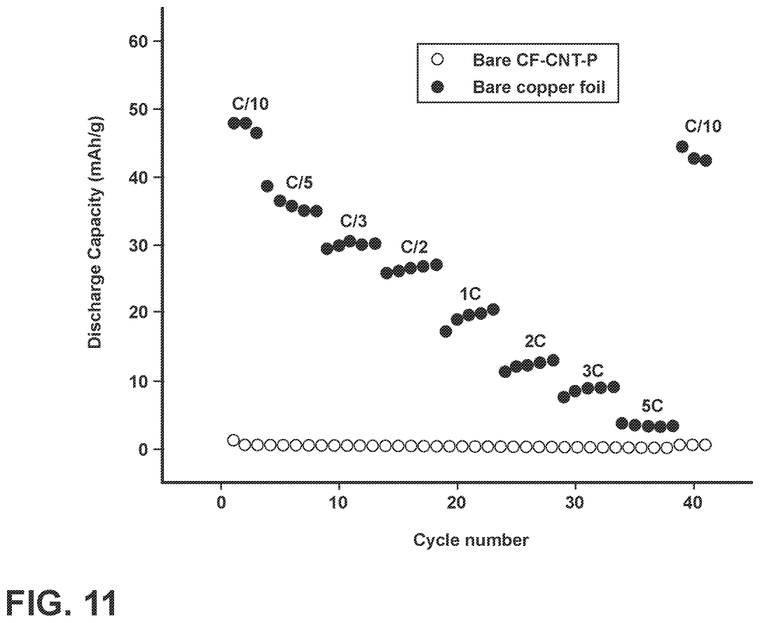

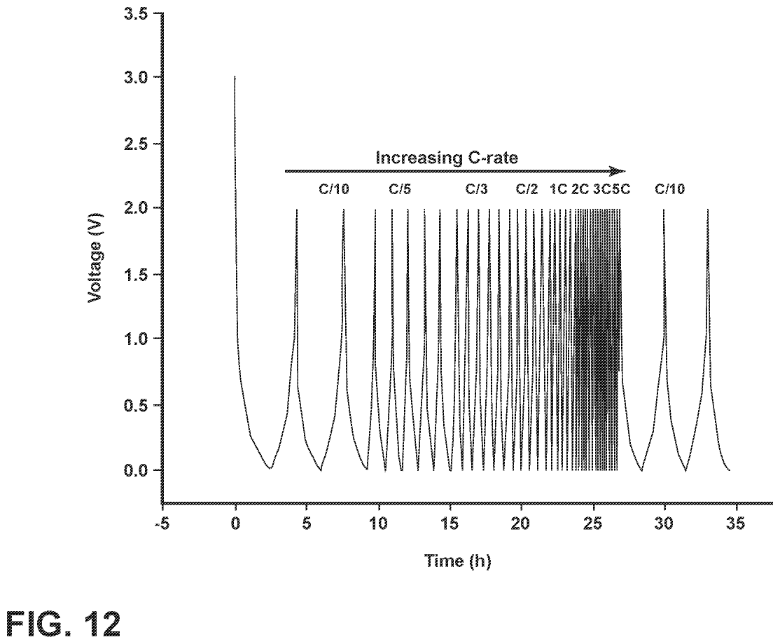

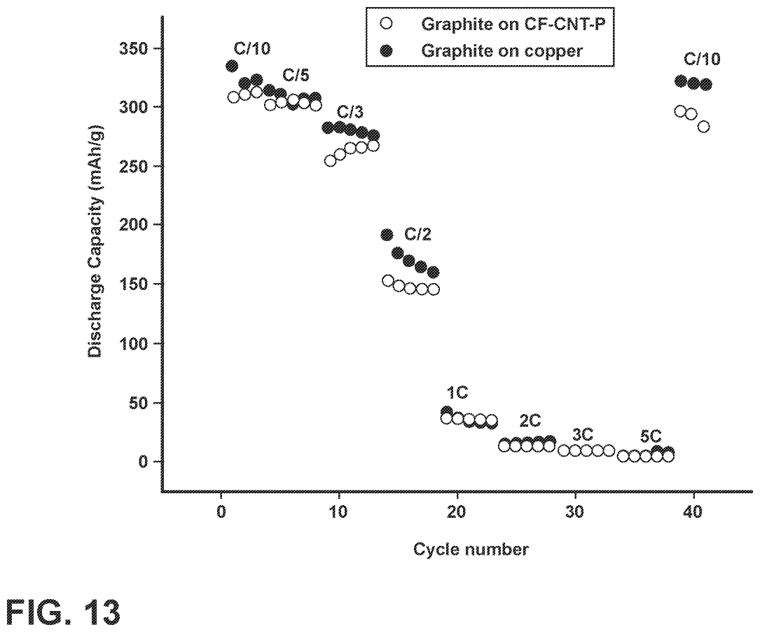

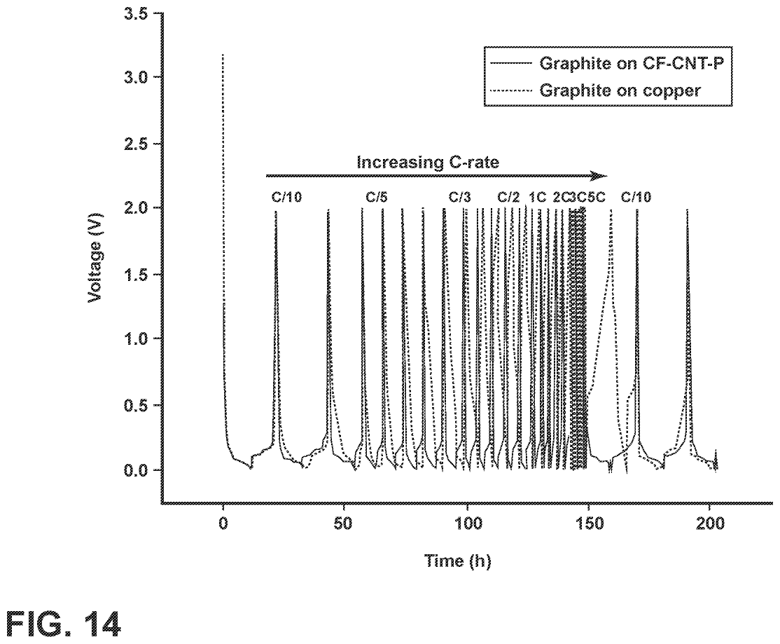

Half-cells having CF-CNT-P alone (without any graphite layer) paired with a lithium-metal electrode were tested to determine their potential contribution to capacity. Similarly, half cells with only copper metal were tested with a lithium-metal electrode. As shown in FIG. 11, CF-CNT-P alone delivered a capacity of approximately 50 mAh/g at C/10 (1C=350 mA/g CF-CNF-P), but the capacity was negligible with the copper foil. The CF-based current collectors thus do provide additional capacity and further increase the energy density. FIG. 12 shows the voltage profile of the half cells with CF-CNT-P and a lithium-metal anode. The voltage profile is similar to common graphite anodes, indicating that CF-CNT-P alone cycled excellently. The rate capability plots of half cells with graphite on CF-CNT-P and copper foil shown in FIG. 13 revealed that graphite electrodes retain similar capacity at different C-rates when deposited either on CF-CNT-P or copper foil. This result confirms that the CF-CNT-P can replace the copper current collectors in graphite anodes. FIG. 14 shows the voltage profiles of the half cells with graphite electrodes deposited on CF-CNT-P and copper foils. These voltage profiles further confirm that graphite anodes deposited on CF-CNT-P cycled nicely at different C-rates, and copper foil can be replaced with CF-CNT-P without compromising the electrochemical performance of cells.

During a peeling test, copper foil was cleanly pulled off from the graphite anode (adhesion strength ˜50 N/m), but CF-CNT-P still had a lot of graphite anode sticking on it, and some graphite was torn off (adhesion strength was very high compared with the limit of the peel tester measurement capability) This indicated that the adhesion strength of the anode layer with copper foil is lower than its adhesion strength with CF-CNT-P. The improved adhesion strength is attributed to the better binding of PVDF present in graphite with the PVDF present in the CF-CNT-P. The improved adhesion strength would be beneficial for long-term cycling because it can mitigate delamination between the anode coating and the current collector.

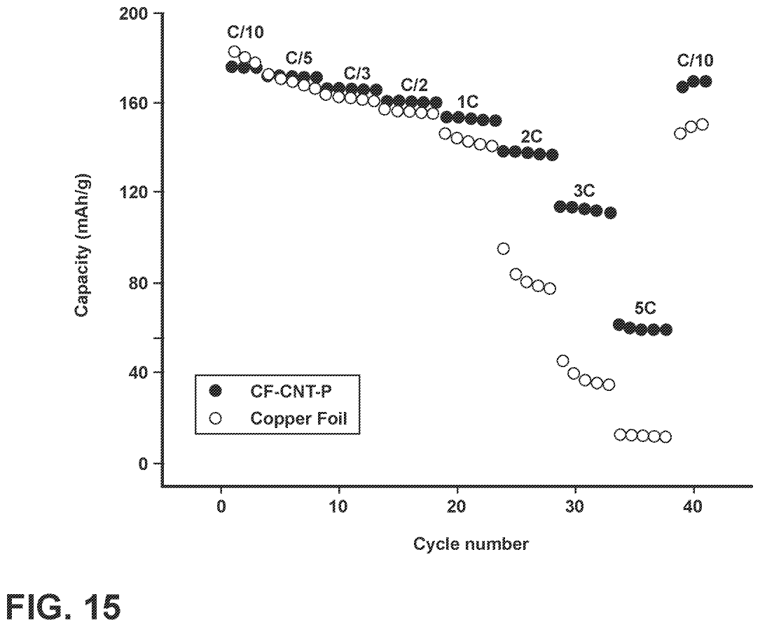

CF-CNT-P current collectors were tested in full cells, in which NMC811 cathodes coated on aluminum foil were paired with graphite anodes coated on a CF-CNT-P current collector or copper foil. The rate capability analysis of full cells was performed at different C-rates ranging from C/10 to 5C with aerial capacity of 3.2 mAh/cm² and an N/P ratio of 1.2. As shown in FIG. 15, the full cells having anodes on the CF-CNT-P and copper foil show similar discharge capacities at low C-rates (C-rate≤C/2). However, cells having graphite anodes on CF-CNT-P retained better discharge capacities at C-rates ≥1C.

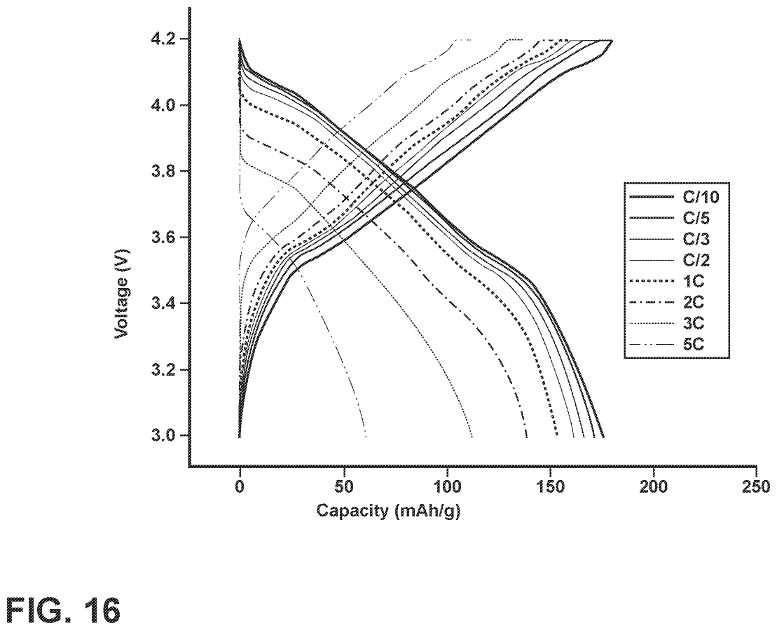

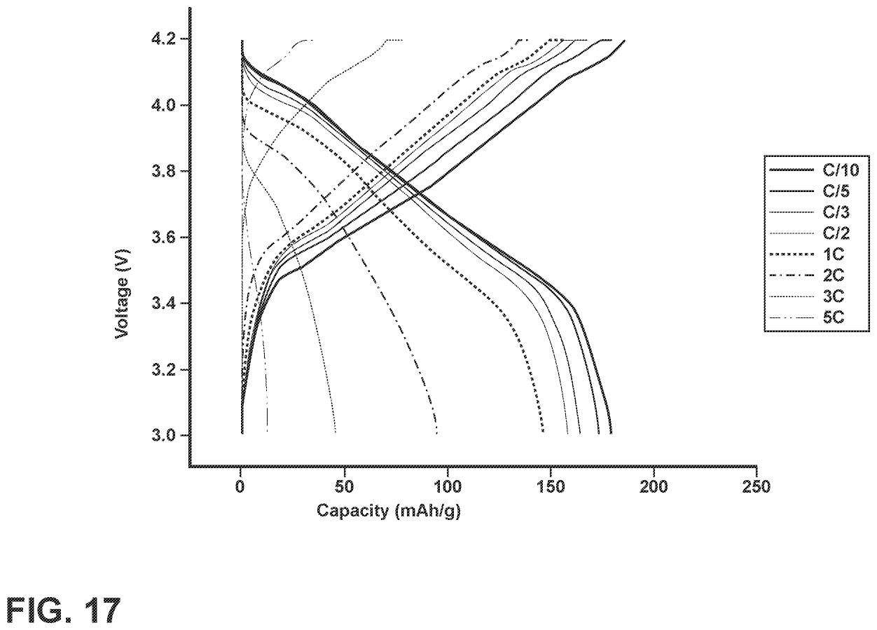

Voltage-capacity profiles for full cells charged at C/3 and discharged at variable C-rates are shown in FIGS. 16 and 17. Voltage-capacity profiles provide insight into the polarization and redox reactions of the cells at different C-rates. At low C-rates (<1C), profiles are similar, but at higher C-rates (≥1C), the profiles fall sharply, indicating fast capacity loss and more polarization. The higher polarization reduces the round-trip efficiency of the charge/discharge cycle, thus compromising the usability of the cells.

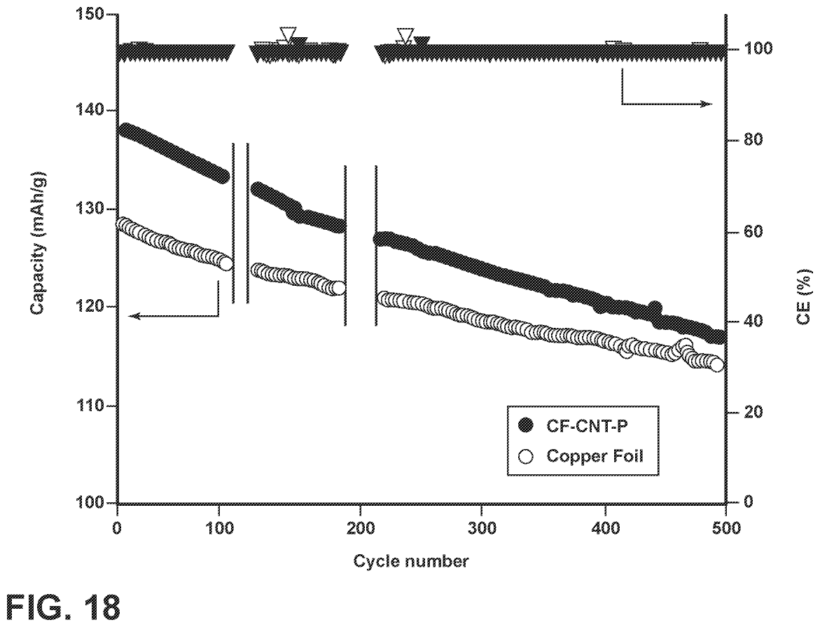

Long-term cycling studies were performed at full cells by pairing NMC811 cathodes coated on aluminum foil with either graphite anodes coated on CF-CNT-P or on copper foils. The full cells with a graphite anode on CF-CNT-P and NMC811 cathode on aluminum foil showed similar cyclic stability in comparison with the full cells with a graphite anode on copper foil and NMC811 cathodes as shown in FIG. 18. However, CF-CNT-P current collector-based cells had higher initial and final discharge capacity after 500 cycles. Similar Coulombic efficiency was observed from the full cells with CF-CNT-P or copper foil as anode current collectors. Discharge capacities at 1C were higher in the rate capability studies (copper foil≈140 mAh/g, CF-CNT-P≈145 mAh/g) when compared to the discharge capacities (copper foil≈128 mAh/g, CF-CNT-P≈138 mAh/g) in the cyclic stability studies.

In sum, the composite disclosed herein showed excellent electronic properties, mechanical properties, and electrochemical stability. The composite was used as a current collector (CF-CNT-P) in Li-ion batteries. The composite current collector showed similar performance to Al-foil and Cu-foil at low C-rates and showed an improved performance at higher C-rates. The composite current collector has a similar thickness as aluminum foil and copper foil and is lighter. The composite current collector can be scaled up and is compatible with roll-to-roll operations. During battery recycling, the composite current collector doesn't need to be separated from cathodes and can be burned out with other components such as binder and carbon black in pyrometallurgical recycling. The composite current collector may also be coated onto a substrate that provides additional mechanical strength and can be peeled off after coating and reused.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A composite current collector for an electrode, the composite current collector comprising:
a plurality of directionally aligned carbon fibers;
a polymer matrix material; and
a conductive material dispersed in the polymer matrix material;
wherein the directionally aligned carbon fibers are impregnated with the polymer matrix material including the dispersed conductive material, the polymer matrix material forming a thin film that fills interstitial spaces between the directionally aligned carbon fibers.

2. The composite current collector of claim 1, wherein the composite current collector is free of metal.

3. The composite current collector of claim 1, wherein the polymer matrix material includes one of poly(L-lactide-co-ε-caprolactone) and polyvinylidene fluoride (PVDF).

4. The composite current collector of claim 1, wherein the conductive material is present in an amount of approximately 1 wt. % to 70 wt. % relative to a total weight of the polymer matrix material and conductive material.

5. The composite current collector of claim 1, wherein the conductive material is one of carbon nanotubes, vapor grown carbon fibers (VGCF), graphene platelets, and carbon black.

6. The composite current collector of claim 1, wherein the thin film has a thickness in a range of 5-50 μm.

7. The composite current collector of claim 6, wherein the thin film has a thickness in a range of 7-15 μm.

8. An electrode comprising:
the composite current collector of claim 1; and
an electrode material coated on the composite current collector.

9. The electrode of claim 8, wherein the electrode has a thickness in a range of 10 to 500 μm.

10. The electrode of claim 8, wherein the electrode material is further defined as a cathode active material.

11. The electrode of claim 8, wherein the electrode material is further defined as an anode active material.

12. A method of making a composite current collector, the method comprising:
preparing a slurry of polymer matrix material and conductive material mixed in a solvent;
directionally aligning carbon fibers; and
impregnating the directionally aligned carbon fibers with the slurry to form a film layer that fills interstitial spaces between the directionally aligned carbon fibers.

13. The method of claim 12, wherein the polymer matrix material includes one of poly(L-lactide-co-ε-caprolactone) and polyvinylidene fluoride (PVDF).

14. The method of claim 12, wherein the solvent is one of chloroform and N-methylpyrrolidone (NMP).

15. The method of claim 12, wherein the conductive material is pre-dispersed in a carrier resin.

16. The method of claim 12, wherein the conductive material is present in the slurry in an amount of approximately 1 wt. % to 70 wt. % based on a total weight of the slurry.

17. The method of claim 12, wherein the conductive material is one of carbon nanotubes, vapor grown carbon fibers (VGCF), graphene platelets, and carbon black.

18. The method of claim 12, wherein the composite current collector has a thickness in a range of 5-50 μm.

19. The method of claim 18, wherein the composite current collector has a thickness in a range of 7-15 μm.

20. The method of claim 12, wherein the film layer of the slurry is formed by one of blade-coating, slot-die coating, spin coating, and spray coating.
